(19) United States
(12) Patent Application Publication
(10) Pub. No.: US 2004/0138064 A1
(43) Pub. Date: Jul. 15, 2004

(54) Adjuvant for water soluble herbicides

(76) Inventor: R. Scott Tann, Sugar Land, TX (US)

Correspondence Address: EXXONMOBIL CHEMICAL COMPANY, P O BOX 2149, BAYTOWN, TX, 77522-2149, US

(21) Appl. No.: 10/712,435

(22) Filed: Nov. 13, 2003

Related U.S. Application Data
(60) Provisional application No. 60/425,816, filed on Nov. 13, 2002.

(51) Int. Cl. A01N 57/18; A01N 25/04; A01N 25/16

(52) U.S. Cl. 504/206; 504/365

(57) ABSTRACT

A method of enhancing inhibition of plant growth comprising mixing a herbicide and an adjuvant to form a herbicidal mixture and applying the herbicidal mixture to the plant, wherein the adjuvant is isopropylammonium sulfate.

This application claims priority of U.S. Provisional Patent Application Ser. No. 60/425,816, filed Nov. 13, 2002.

### FIELD OF THE INVENTION

The present invention relates to adjuvants for water-soluble herbicides. More specifically, the present invention relates to the use of an alkylamine sulfate as an adjuvant for water-soluble herbicides.

### DESCRIPTION OF THE RELATED ART

The use of ammonium sulfate as a adjuvant is disclosed in AU-B-80459/94. Ammonium sulfate increases the effectiveness of N-phosphonomethylglycine (hereafter “glyphosate”) by providing faster, more efficient uptake of the glyphosate. This results in enhanced weed control and quicker knock-down of weeds. However, aqueous formulations of glyphosate and ammonium sulfate are unstable. The glyphosate salt precipitates, which necessitates preparing the mixture of glyphosate and ammonium sulfate shortly prior to use.

A need exists for an adjuvant that improves the stability of the aqueous mixture of an ammonium sulfate-type adjuvant and a water-soluble herbicide, for example, glyphosate. A need exists for an adjuvant that provides increased efficacy of the aqueous mixture of a water-soluble herbicide.

### DESCRIPTION OF THE DRAWINGS

FIG. 1 shows a graph of the morningglory fresh weight versus the adjuvant type and amount.

FIG. 2 shows a graph of the 7, 14 and 21 day percent control versus the adjuvant type and amount.

FIG. 3 shows a graph of the velvetleaf fresh weight versus the adjuvant type and amount.

FIG. 4 shows a graph of the 7, 14 and 21 day percent control versus the adjuvant type and amount.

FIG. 5 shows a graph of the percent reduction of the sorghum plant height after 15 days with distilled water versus the molar concentration of adjuvant.

FIG. 6 shows a graph of the percent reduction of the sorghum plant height after 15 days with hard water versus the molar concentration of adjuvant.

FIG. 7 shows a graph of the percent reduction of the sorghum plant fresh weight after 15 days with distilled water versus the molar concentration of adjuvant.

FIG. 8 shows a graph of the percent reduction of the sorghum plant fresh weight after 15 days with hard water versus the molar concentration of adjuvant.

FIG. 9 shows a graph of the percent reduction of the soybean plant height after 15 days with distilled water versus the molar concentration of adjuvant.

FIG. 10 shows a graph of the percent reduction of the soybean plant height after 15 days with hard water versus the molar concentration of adjuvant.

FIG. 11 shows a graph of the percent reduction of the soybean plant fresh weight after 15 days with distilled water versus the molar concentration of adjuvant.

FIG. 12 shows a graph of the percent reduction of the soybean plant fresh weight after 15 days with hard water versus the molar concentration of adjuvant.

### SUMMARY OF THE INVENTION

A method of using an adjuvant according to the present invention provides benefits over the prior art for enhancing the efficacy of herbicides in the inhibition of plant growth.

In one embodiment according to the present invention, a method of inhibiting plant growth comprises mixing a herbicide, an adjuvant and a carrier, preferably water, to form a herbicidal mixture and applying the herbicidal mixture to the plant, wherein the adjuvant is isopropylammonium sulfate.

In another embodiment according to the present invention, the method of inhibiting plant growth comprises mixing a herbicide, an adjuvant and a carrier, preferably water, to form a herbicidal mixture and applying the herbicidal mixture to the plant, wherein the adjuvant is isopropylammonium sulfate and wherein the herbicide is glyphosate.

In another embodiment according to the present invention, the method of inhibiting plant growth comprises mixing glyphosate, isopropylammonium sulfate and a carrier, preferably water, to form a herbicidal mixture and applying the herbicidal mixture to the plant, wherein the plant is morningglory or velvetleaf.

### DETAILED DESCRIPTION OF THE INVENTION

The present invention provides an adjuvant for aqueous herbicide formulations containing water-soluble herbicides, exemplified by glyphosate. The present invention provides an adjuvant having increased hydrophobicity relative to ammonium sulfate. The present invention provides an adjuvant with an increased affinity for hydrophobic plant surfaces to increase longer contact and increased uptake of the water-soluble herbicide through the hydrophobic plant surface.

The aqueous herbicidal formulation comprises glyphosate or a water-soluble salt of glyphosate. Suitable water-soluble salts of glyphosate include water-soluble alkylammonium salts. In particular, isopropylamine is used to neutralize the acid of glyphosate to form the water soluble isopropylammonium glyphosate.

The adjuvant includes alkyl ammonium salts, particularly alkyl ammonium sulfates, and more particularly isopropylammonium sulfate. The isopropylammonium sulfate is prepared by any convention method, such as neutralization of isopropylamine with sulfuric acid. Isopropylamine is commercially available from Air Products. Additionally, conventional methods are known for the conversion of isopropyl alcohol to isopropyl amine.

Glyphosate may be dissolved in an alkylamine, preferably isopropylamine. Alternatively, the glyphosate may be slurried in water.

In one method, an aqueous slurry of glyphosate is acidified by the addition of sulfuric acid, preferably concentrated sulfuric acid, to an acidic pH, preferably less than 2. The alkylamine, preferably isopropylamine, is added to the acidified mixture until the pH is adjusted into the range of about 3.5 to about 6 to form an aqueous mixture of isopropylammonium glyphosate and isopropylammonium sulfate.

In another method, glyphosate acid or a water-soluble glyphosate salt is dissolved to form an alkylammonium salt of glyphosate, preferably the isopropylammonium salt, and the mixture acidified by the addition of aqueous sulfuric acid to provide the alkylammonium sulfate, preferably isopropylammonium sulfate.

In another method, a mixture comprising an alkylammonium sulfate, preferably isopropylammonium sulfate, is prepared by diluting concentrated sulfuric acid in water to form an aqueous solution of sulfuric acid and adding an alkylamine, preferably isopropylamine, to the aqueous solution of sulfuric acid to form a mixture of alkylammonium sulfate, preferably isopropylammonium sulfate, and then mixing glyphosate with the mixture. Optionally, additional alkylamine, preferably isopropylamine, is added to form an aqueous solution of isopropylammonium sulfate and alkylammonium glyphosate.

In one embodiment according to the present invention, a method of inhibiting plant growth comprises mixing a herbicide, an adjuvant and water to form a herbicidal mixture and applying the herbicidal mixture to the plant, wherein the adjuvant is isopropylammonium sulfate.

In another embodiment according to the present invention, a method of inhibiting plant growth comprises mixing a herbicide, an adjuvant and water to form a herbicidal mixture and applying the herbicidal mixture to the plant, wherein the adjuvant is isopropylammonium sulfate and wherein the herbicide is glyphosate.

In another embodiment according to the present invention, a method of inhibiting plant growth comprises mixing glyphosate, isopropylammonium sulfate and water to form a herbicidal mixture and applying the herbicidal mixture to the plant, wherein the plant is morningglory or velvetleaf.

TABLE 1

| | | | | Velvet Leaf | | | Morning Glory | | |
|---|---|---|---|---|---|---|---|---|---|
| | | | | % Control | | | % Control | | |
| Water | | Sulfate, | Sulfate, | 7 | 14 | 21 | 7 | 14 | 21 |
| Hardness | Formulation | Weight | moles | DAT | DAT | DAT | DAT | DAT | DAT |
| 0 ppm | Glyphosate | 0 | 0 | 52 | 84 | 88 | 56 | 56 | 50 |
| | Glyphosate + AMS | 4.25 | 0.0385 | 64 | 86 | 90 | 54 | 52 | 49 |
| | Glyphosate + AMS | 8.5 | 0.0771 | 64 | 77 | 91 | 62 | 58 | 57 |
| | Glyphosate + AMS | 17.0 | 0.1542 | 71 | 84 | 89 | 64 | 61 | 57 |
| | Glyphosate + MIPAS | 13.92 | 0.0771 | 70 | 88 | 95 | 67 | 62 | 57 |
| | Glyphosate + MIPAS | 27.84 | 0.1542 | 73 | 89 | 95 | 62 | 63 | 56 |
| | Glyphosate + MIPAS | 55.68 | 0.3084 | 79 | 92 | 97 | 65 | 67 | 61 |
| 1000 ppm | Glyphosate | 0 | 0 | 48 | 56 | 52 | 51 | 48 | 46 |
| | Glyphosate + AMS | 4.25 | 0.0385 | 66 | 81 | 82 | 60 | 53 | 49 |
| | Glyphosate + AMS | 8.5 | 0.0771 | 65 | 86 | 84 | 64 | 60 | 60 |
| | Glyphosate + AMS | 17.0 | 0.1542 | 70 | 84 | 85 | 65 | 64 | 56 |
| | Glyphosate + MIPAS | 13.92 | 0.0771 | 66 | 83 | 86 | 65 | 62 | 59 |
| | Glyphosate + MIPAS | 27.84 | 0.1542 | 74 | 89 | 89 | 64 | 65 | 59 |
| | Glyphosate + MIPAS | 55.68 | 0.3084 | 77 | 90 | 90 | 66 | 68 | 62 |
| Untreated | | — | — | 0 | 0 | 0 | 0 | 0 | 0 |
| (Control) | | | | | | | | | |

MIPAS is isopropylammonium sulfate.
AMS is ammonium sulfate.
The sulfate weight is expressed as a normalized value of pounds per hundred gallons of carrier. The sulfate molar concentrations are calculated values from the corresponding sulfate weights.
DAT = Days After Treatment

TABLE 2

| | | | | Velvet Leaf | Morning Glory |
|---|---|---|---|---|---|
| | | | | Fresh Weight | Fresh Weight |
| Water | | Sulfate, | Sulfate, | 21 | 21 |
| Hardness | Formulation | Weight | moles | DAT | DAT |
| 0 ppm | Glyphosate | 0 | 0 | 1.1 | 1.4 |
| | Glyphosate + AMS | 4.25 | 0.0385 | 0.9 | 1.5 |
| | Glyphosate + AMS | 8.5 | 0.0771 | 1.3 | 1.1 |
| | Glyphosate + AMS | 17.0 | 0.1542 | 0.9 | 1.3 |
| | Glyphosate + MIPAS | 13.92 | 0.0771 | 1.2 | 1.1 |
| | Glyphosate + MIPAS | 27.84 | 0.1542 | 1.0 | 1.1 |
| | Glyphosate + MIPAS | 55.68 | 0.3084 | 0.7 | 1.0 |
| 1000 ppm | Glyphosate | 0 | 0 | 1.8 | 1.9 |
| | Glyphosate + AMS | 4.25 | 0.0385 | 1.5 | 1.6 |
| | Glyphosate + AMS | 8.5 | 0.0771 | 1.6 | 1.2 |
| | Glyphosate + AMS | 17.0 | 0.1542 | 1.4 | 1.2 |
| | Glyphosate + MIPAS | 13.92 | 0.0771 | 1.5 | 1.2 |
| | Glyphosate + MIPAS | 27.84 | 0.1542 | 1.2 | 1.2 |
| | Glyphosate + MIPAS | 55.68 | 0.3084 | 1.0 | 1.0 |
| Untreated | | — | — | 3.6 | 1.8 |
| (Control) | | | | | |

MIPAS is isopropylammonium sulfate.
AMS is ammonium sulfate.
The sulfate weight is expressed as a normalized value of pounds per hundred gallons of carrier. The sulfate molar concentrations are calculated values from the corresponding sulfate weights.
DAT = Days After Treatment

TABLE 3

| Plant Height | | | | Sorghum | Soybean |
|---|---|---|---|---|---|
| Water | | Sulfate, | Sulfate, | % Control | % Control |
| Hardness | Formulation | Weight | moles | 15 DAT | 15 DAT |
| 0 ppm | Glyphosate | 0 | 0 | 41.04 | 47.55 |
| | Glyphosate + | 4.25 | 0.0385 | 48.86 | 53.20 |
| | AMS | | | | |
| | Glyphosate + | 8.5 | 0.0771 | 61.10 | 46.43 |
| | AMS | | | | |
| | Glyphosate + | 17 | 0.1542 | 45.56 | 46.35 |
| | AMS | | | | |
| | Glyphosate + | 6.95 | 0.0386 | 46.82 | 53.19 |
| | MIPAS | | | | |
| | Glyphosate + | 13.9 | 0.0771 | 53.31 | 41.43 |
| | MIPAS | | | | |
| | Glyphosate + | 27.8 | 0.1542 | 36.88 | 56.61 |
| | MIPAS | | | | |
| | Glyphosate + | 55.7 | 0.3086 | 51.76 | 48.51 |
| | MIPAS | | | | |
| 342 ppm | Glyphosate | 0 | 0 | 14.55 | 47.77 |
| | Glyphosate + | 4.25 | 0.0385 | 38.35 | 46.53 |
| | AMS | | | | |
| | Glyphosate + | 8.5 | 0.0771 | 55.74 | 52.82 |
| | AMS | | | | |
| | Glyphosate + | 17 | 0.1542 | 56.50 | 51.41 |
| | AMS | | | | |
| | Glyphosate + | 6.95 | 0.0386 | 44.05 | 52.91 |
| | MIPAS | | | | |
| | Glyphosate + | 13.9 | 0.0771 | 50.94 | 47.70 |
| | MIPAS | | | | |
| | Glyphosate + | 27.8 | 0.1542 | 39.62 | 44.41 |
| | MIPAS | | | | |
| | Glyphosate + | 55.7 | 0.3086 | 52.70 | 53.21 |
| | MIPAS | | | | |
| Untreated | | — | — | 0 | 0 |
| (Control) | | | | | |

MIPAS is isopropylammonium sulfate.
AMS is ammonium sulfate.
The sulfate weight is expressed as a normalized value of pounds per hundred gallons of carrier. The sulfate molar concentrations are calculated values from the corresponding sulfate weights.
DAT = Days After Treatment

TABLE 4

| Plant Weight | | | | Sorghum | Soybean |
|---|---|---|---|---|---|
| Water | | Sulfate, | Sulfate, | % Control | % Control |
| Hardness | Formulation | Weight | moles | 15 DAT | 15 DAT |
| 0 ppm | Glyphosate | 0 | 0 | 59.86 | 75.60 |
| | Glyphosate + AMS | 4.25 | 0.0385 | 60.35 | 74.53 |
| | Glyphosate + AMS | 8.5 | 0.0771 | 84.35 | 64.51 |
| | Glyphosate + AMS | 17 | 0.1542 | 84.27 | 72.60 |
| | Glyphosate + MIPAS | 6.95 | 0.0386 | 67.64 | 73.75 |
| | Glyphosate + MIPAS | 13.9 | 0.0771 | 81.03 | 71.58 |
| | Glyphosate + MIPAS | 27.8 | 0.1542 | 58.58 | 81.87 |
| | Glyphosate + MIPAS | 55.7 | 0.3086 | 84.04 | 74.30 |
| 342 ppm | Glyphosate | 0 | 0 | 40.97 | 59.20 |
| | Glyphosate + AMS | 4.25 | 0.0385 | 48.74 | 70.74 |
| | Glyphosate + AMS | 8.5 | 0.0771 | 66.58 | 69.49 |
| | Glyphosate + AMS | 17 | 0.1542 | 85.03 | 74.43 |
| | Glyphosate + MIPAS | 6.95 | 0.0386 | 62.35 | 70.13 |
| | Glyphosate + MIPAS | 13.9 | 0.0771 | 76.69 | 58.94 |
| | Glyphosate + MIPAS | 27.8 | 0.1542 | 80.99 | 73.81 |
| | Glyphosate + MIPAS | 55.7 | 0.3086 | 75.52 | 71.27 |
| Untreated (Control) | | — | — | 0 | 0 |

MIPAS is isopropylammonium sulfate.
AMS is ammonium sulfate.
The sulfate weight is expressed as a normalized value of pounds per hundred gallons of carrier. The sulfate molar concentrations are calculated values from the corresponding sulfate weights.
DAT = Days After Treatment

### EXAMPLE 1

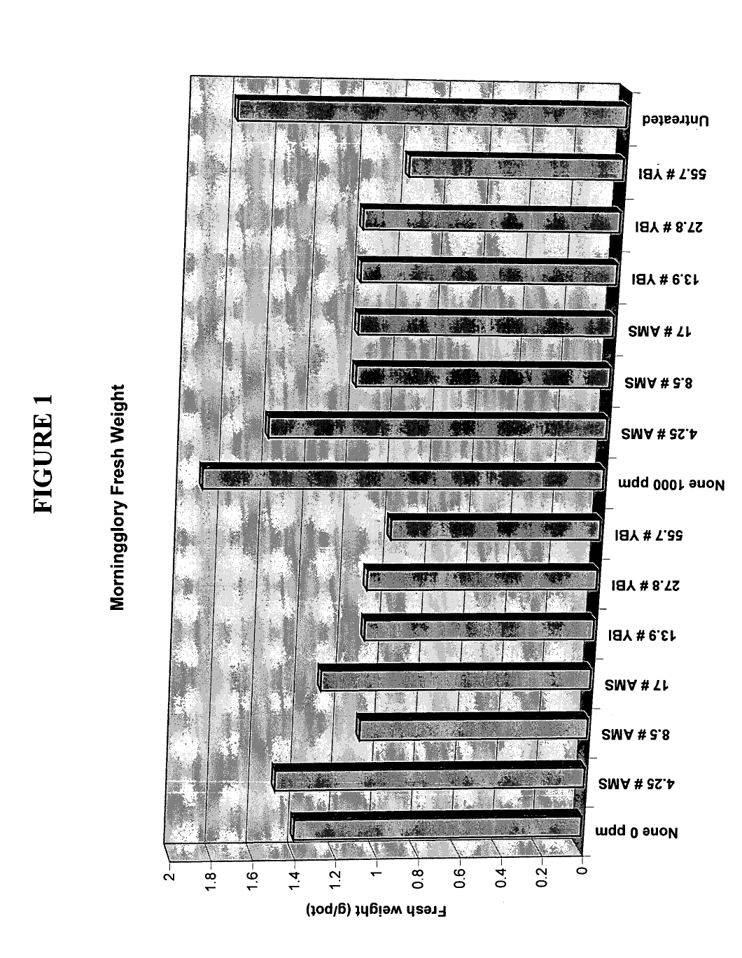

The formulations shown in Table 1 and Table 2 are either glyphosate and ammonium sulfate (AMS) or glyphosate and isopropylammonium sulfate (MIPAS). In Table 1 and Table 2, 0 ppm hardness refers to the absence of minerals such as calcium ions and 1000 ppm hardness refers to the amount of calcium ions present. The moles of sulfate indicate the amount of isopropylammonium sulfate or ammonium sulfate per liter. The aqueous solution was applied to the plots at a level of 10 gallons per acre. The two tested plants were Morningglory Entireleaf (abutilon theophrasti medik) and Velvetleaf (ipomoea hederacea (L.) jacq. Var. integriuscula gray). The data collected 7 days, 14 days and 21 days after treatment is shown in FIGS. 1-4. The term YBI in the Figures indicates the adjuvant was isopropylammonium sulfate.

The herbicidal solutions were applied in a cabinet using a Lodrift nozzle having a nozzle size 110015. The spray apparatus was operated at 40 psi using air as the propellant and water as a carrier. The boom height was 13.5 inches. The ground speed was 2.6 miles per hour. The morningglory was at the three-leaf stage when the herbicidal solution was applied. The velvetleaf was 4-6 inches in height when the herbicidal solution was applied. The normalized spray volume was 10 gallons per acre.

The Figures show values of pounds of ammonium sulfate or isopropylammonium sulfate per hundred gallons. The actual solutions used were nominally ten gallons of the sulfate in water, e.g. one-tenth of the sulfate per hundred gallons of carrier, with twenty fluid ounces of glyphosate. Twenty fluid ounces of glyphosate contains about 0.63 pounds of glyphosate active ingredient (AI) reported as the isopropylammonium. The glyphosate active ingredient (AI) as the isopropylammonium salt is related to the glyphosate acid equivalents (AE) by the formula: (0.7142)(AI)=AE.

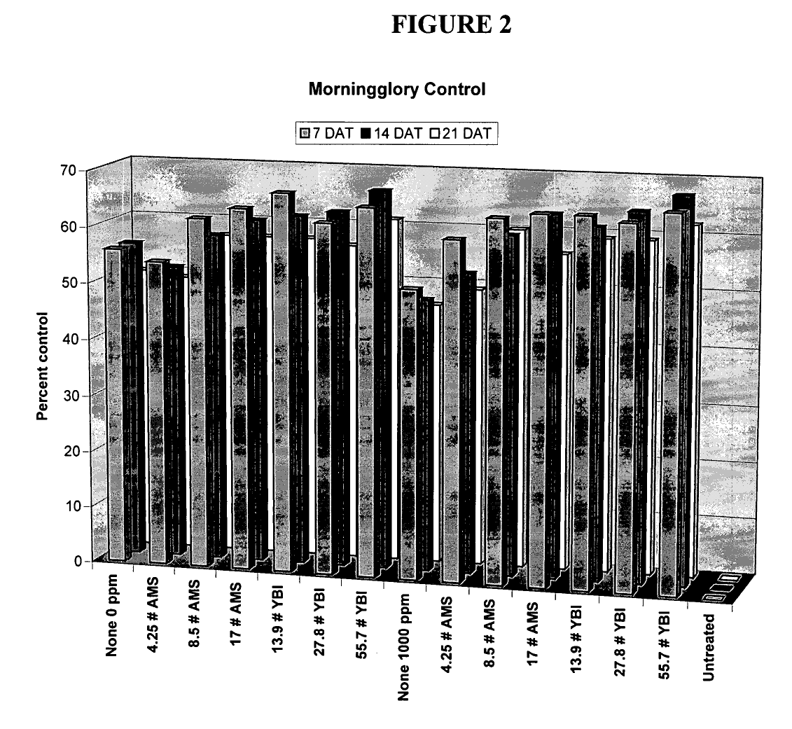

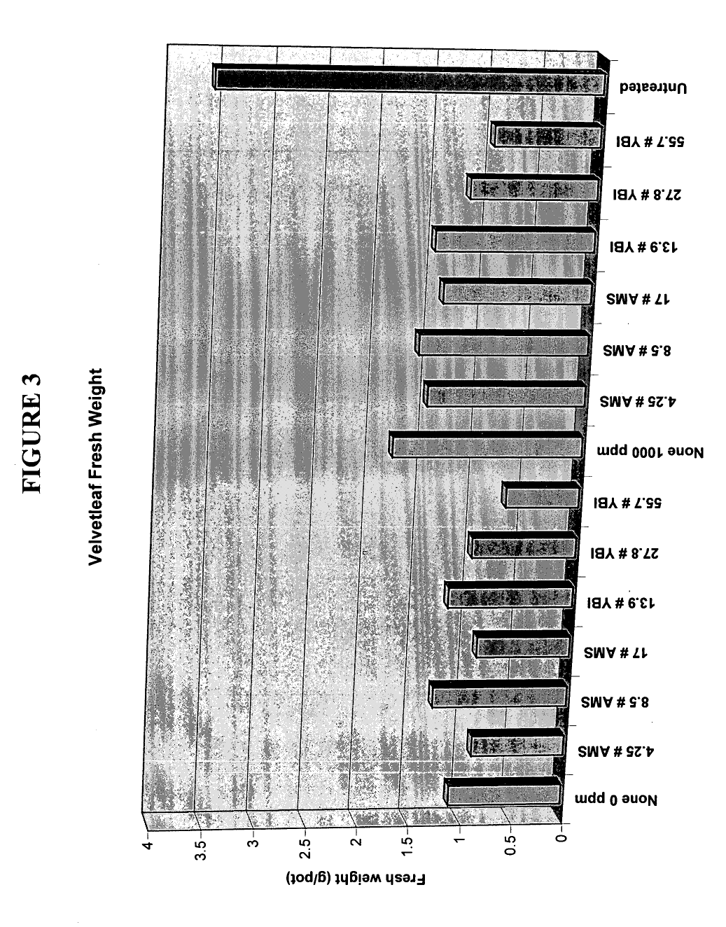

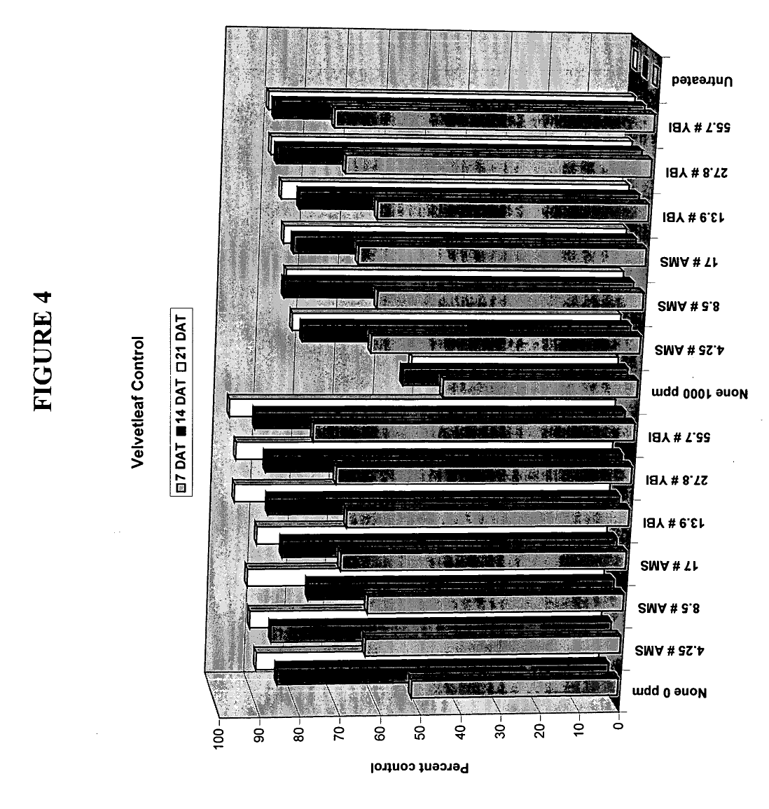

FIGS. 1 and 3 show the fresh weight of morningglory and velvetleaf, respectively. The fresh weight was determined by cutting the stem of the plant flush with the ground and weighing the plant. The weight is reported as grams per pot since a single plant was grown in each pot. FIGS. 2 and 4 show the percent control at 7, 14 and 21 days for morningglory and velvetleaf, respectively.

Bartlett's test (commonly used in the agricultural business) was used to statistically analyze the results. The height reduction of velvetleaf using MIPAS at water hardness concentrations of 0 ppm and 1000 ppm was statistically different from the no adjuvant case, and the height reduction of velvetleaf at high MIPAS concentrations were statistically different from the AMS results at a water hardness concentration of 0 ppm. Although the MIPAS results were better than the AMS results, the differences between the MIPAS and AMS results at a water hardness concentration of 1000 ppm were not statistically significant. The fresh weight of velvetleaf at a water hardness concentration of 0 ppm showed no statistical difference with the use of MIPAS or AMS and no adjuvant. The fresh weight of velvetleaf at a water hardness concentration of 1000 ppm showed no statistical difference between the use of AMS and no adjuvant, but there was a statistically significant difference between the use of MIPAS at the two higher concentrations and no adjuvant (although there is no statistically significant difference between the use of MIPAS and AMS).

The height reduction of morningglory using AMS at the two highest concentrations and all MIPAS concentrations at a water hardness concentration of 0 ppm was statistically different from the no adjuvant case, but there is no statistically significant difference between the MIPAS and AMS results. The height reduction of morningglory at the two higher concentrations of AMS and all the MIPAS treatments with a water hardness concentration of 1000 ppm were statistically different from the no adjuvant case. The differences between the MIPAS and AMS results were not statistically significant with a water hardness concentration of 1000 ppm. There was a statistical difference between the MIPAS and the no adjuvant case for the fresh weight of morningglory at a water hardness concentration of 0 ppm, but there was no statistically significant difference between AMS and MIPAS. The fresh weight of morningglory at a water hardness concentration of 1000 ppm showed a statistical difference between the use of the higher concentrations of AMS and the no adjuvant case. All MIPAS plant weights were statistically different from the no adjuvant case, but there was no statistically significant difference between the use of MIPAS and AMS cases.

### EXAMPLE 2

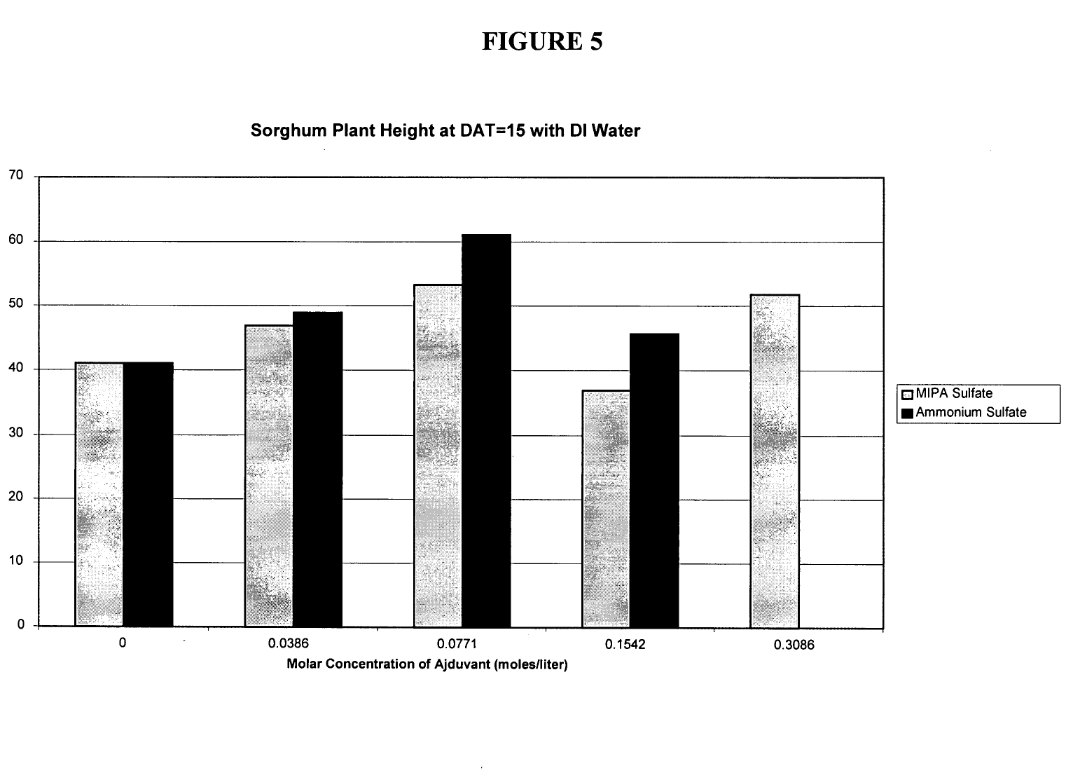

The formulations shown in Table 3 and Table 4 are either glyphosate and ammonium sulfate (AMS) or glyphosate and isopropylammonium sulfate (MIPAS). In Table 3 and Table 4, 0 ppm hardness refers to the absence of minerals such as calcium ions and 342 ppm hardness refers to the amount of calcium ions present. The moles of sulfate indicate the amount of isopropylammonium sulfate or ammonium sulfate per liter. The aqueous solution was applied to the plots at a level of 10 gallons per acre. The two tested plants were soybeans (Glycine max) and grain sorghum (Milo), (Sorghum bicolar). The data collected 15 days after treatment is shown in FIGS. 5-12.

The herbicidal solutions were applied in a greenhouse using a Spray chamber with an FF nozzle having a nozzle size 8001EVS. The spray apparatus was operated at 38 psi and the height of the nozzle was 9.75 inches. The watering frequency was every 6 hours for 5 minutes. The daytime temperature was 85° F. and the nighttime temperature was 70° F. with a 16 hour day. The soybean was 4-4.5 inches with one trifoliate leaf present when the herbicidal solution was applied. The grain sorghum was 4-8 inches with 3-4 leaves present when the herbicidal solution was applied.

The Figures show values of moles of ammonium sulfate or isopropylammonium sulfate per liter. The actual solution used on the grain sorghum contained 0.13 pounds of glyphosate active ingredient per 10 gallons of water per acre. The actual solution used on the soybean contained 0.75 pounds glyphosate active ingredient per 10 gallons of water per acre.

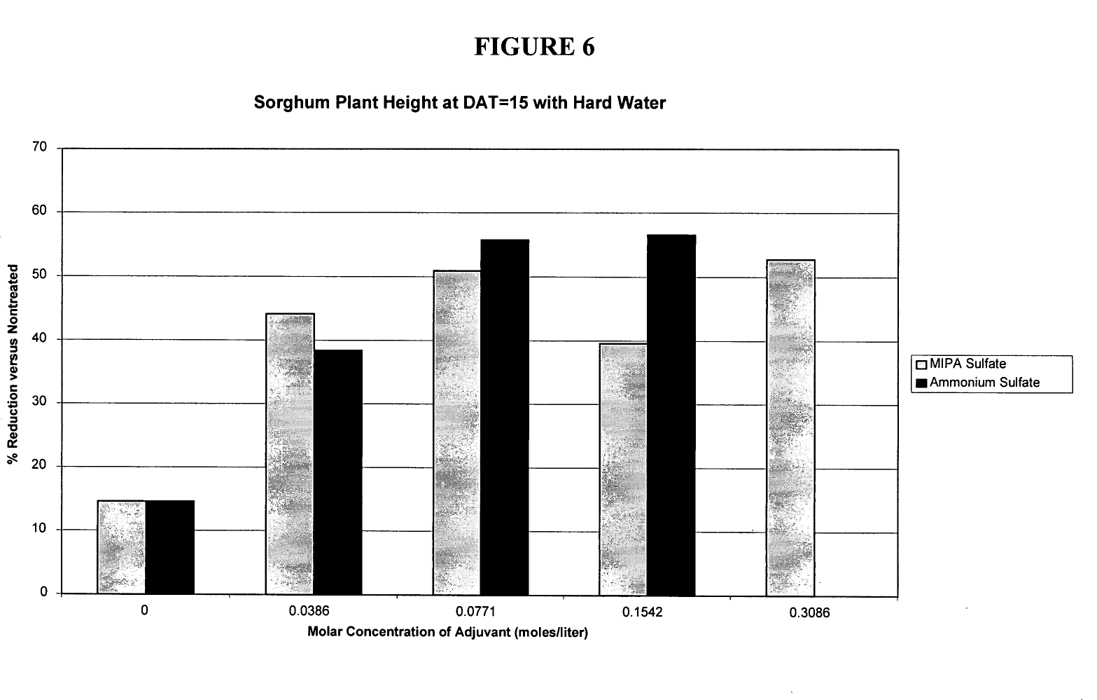

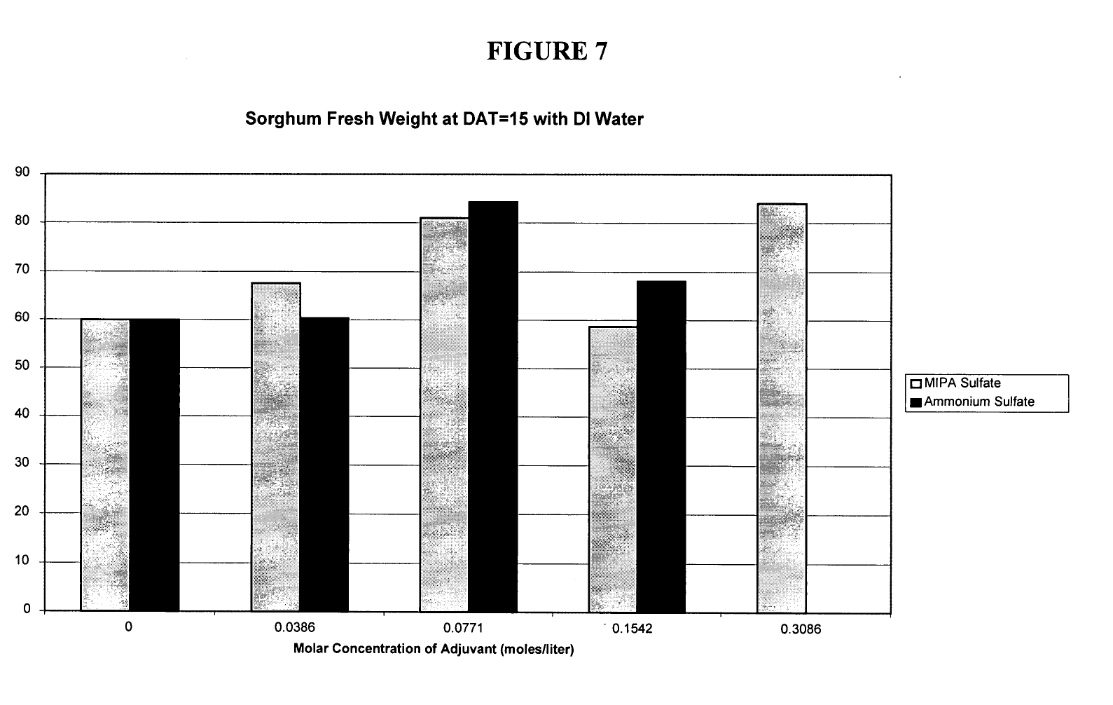

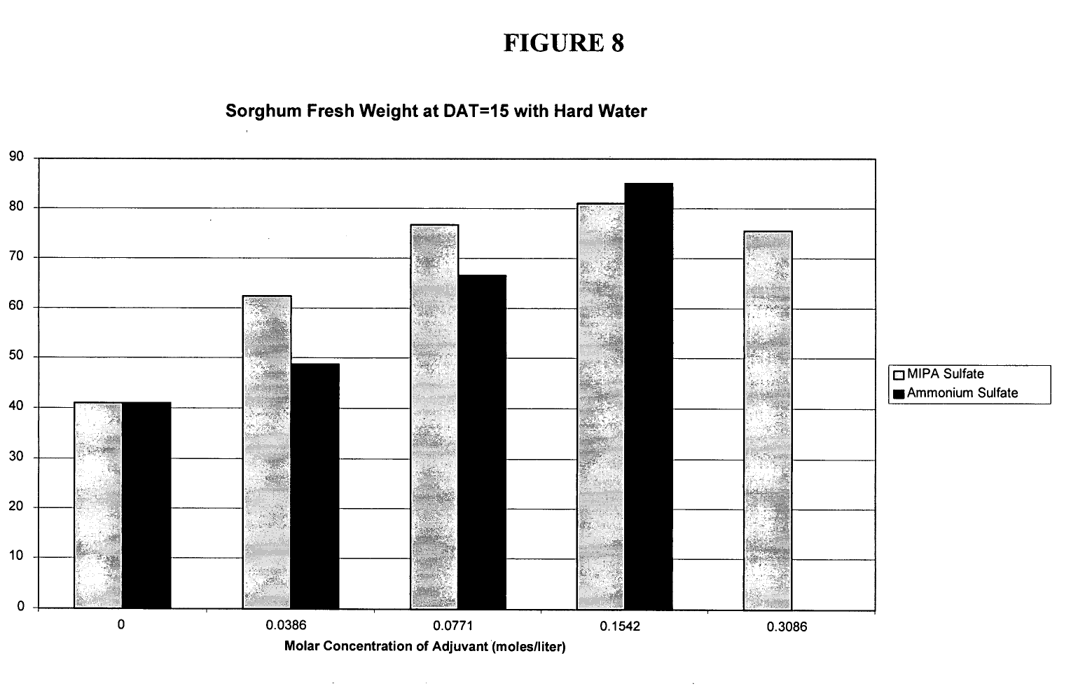

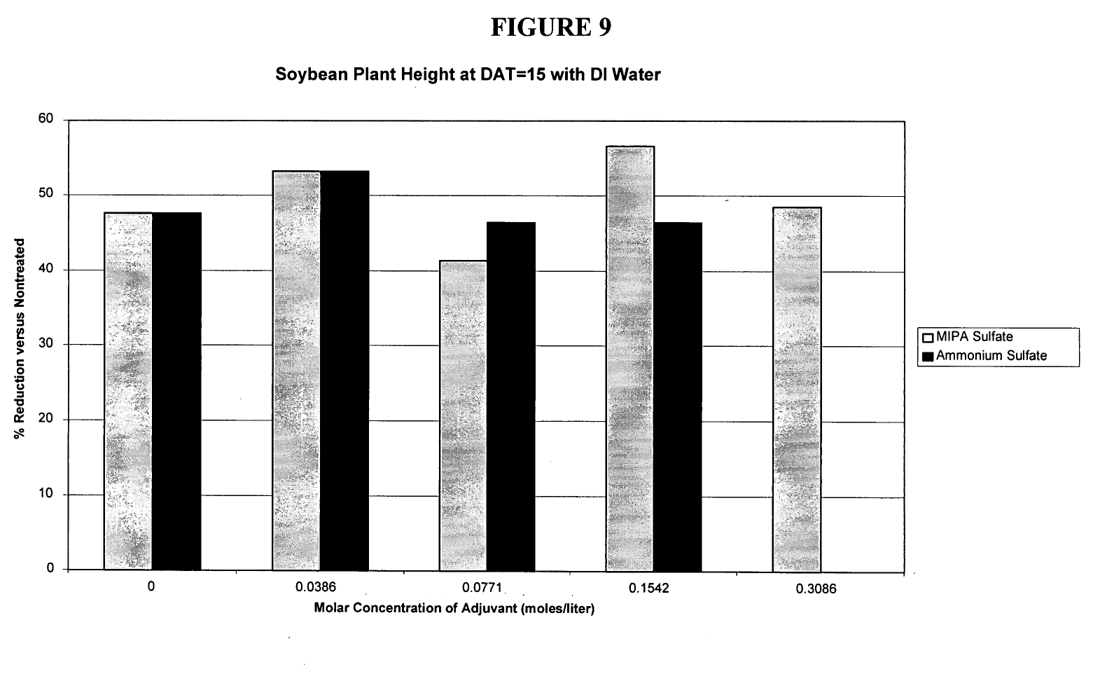

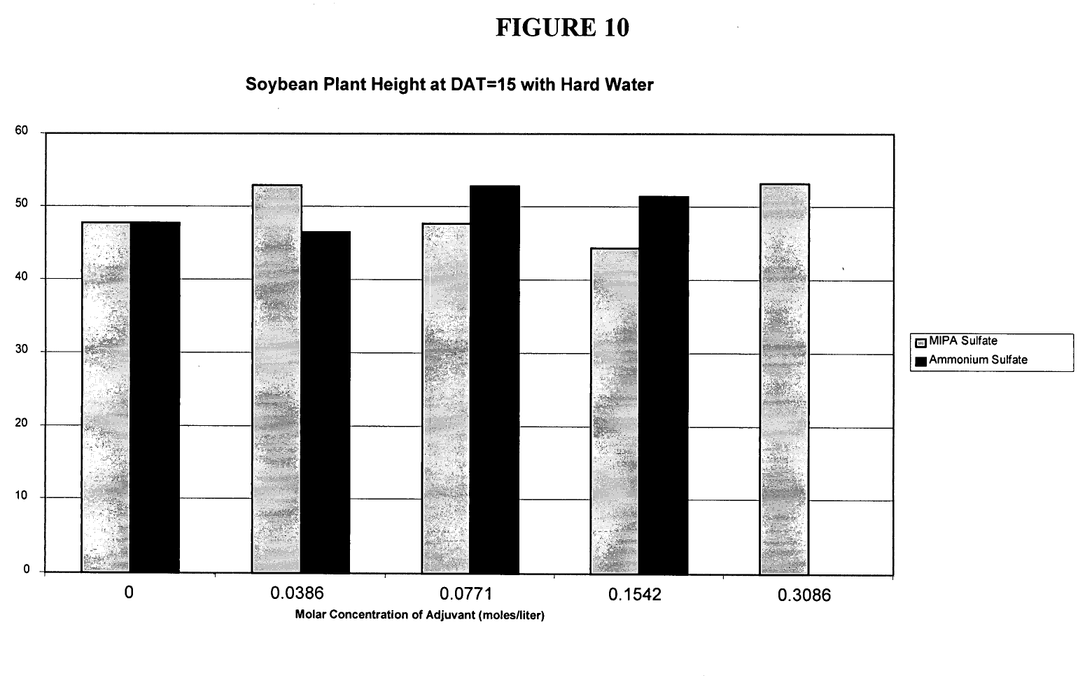

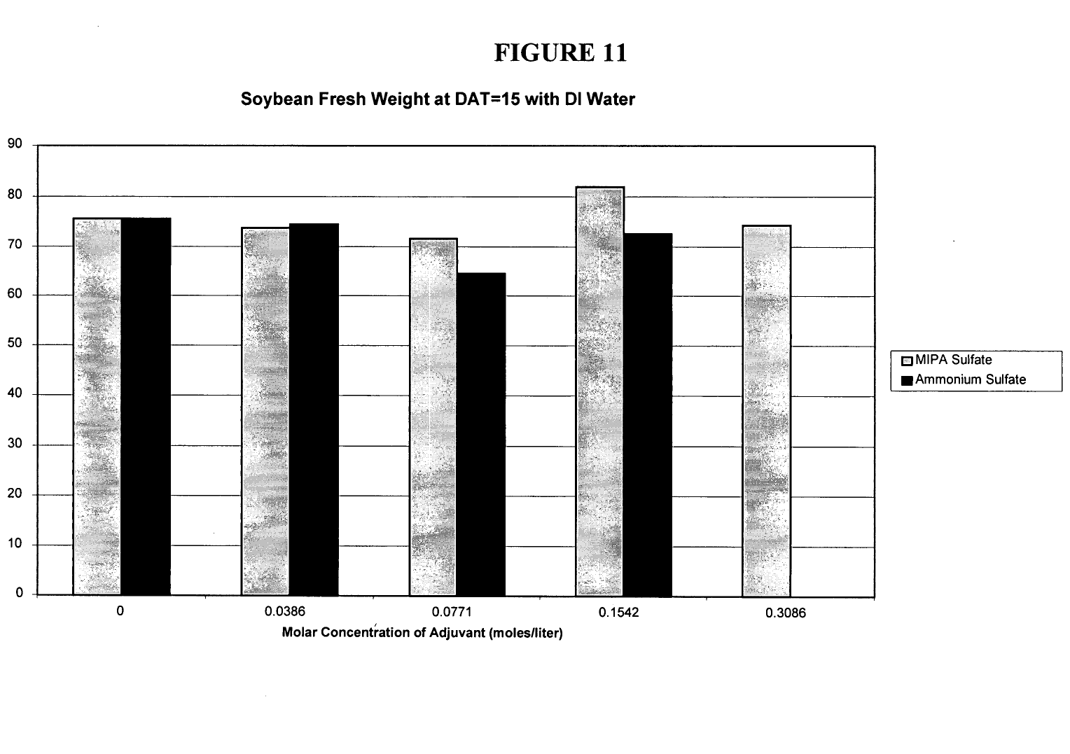

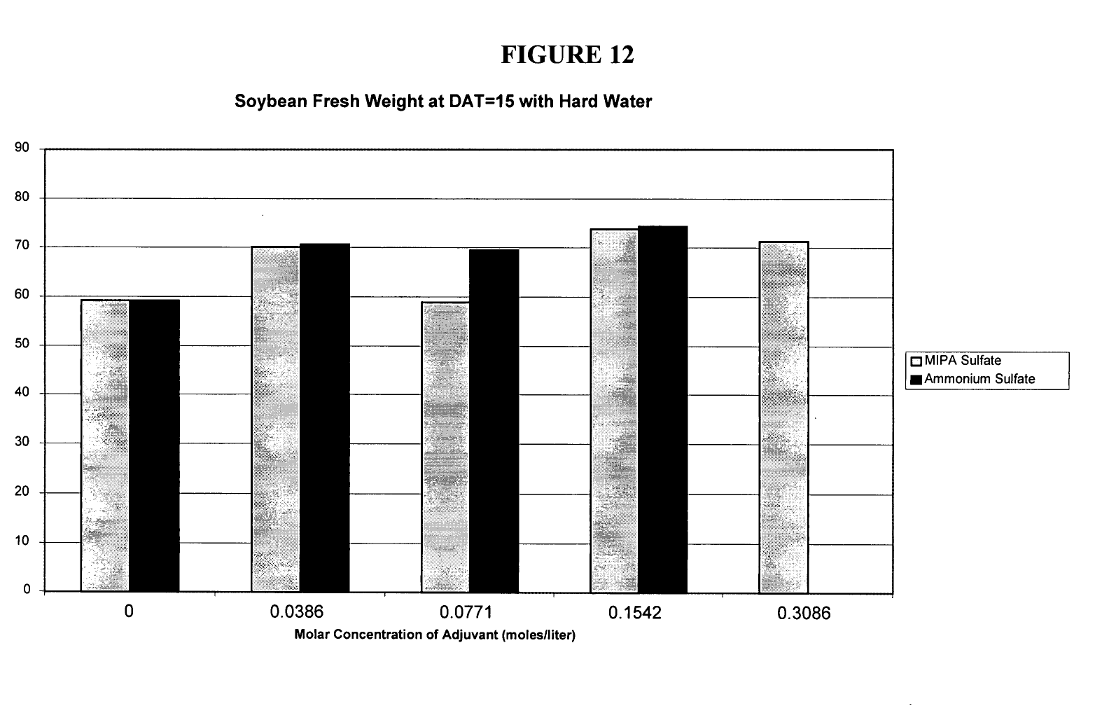

FIGS. 5 and 9 show the height of sorghum and soybean, respectively, when distilled water was used, as a percent reduction of the height of the control after 15 days. FIGS. 6 and 10 show the height of sorghum and soybean, respectively, when hard water was used, as a percent reduction of the height of the control after 15 days. FIGS. 7 and 11 show the fresh weight of sorghum and soybean, respectively, when distilled water was used, as a percent reduction of the weight of the control after 15 days. FIGS. 8 and 12 show the fresh weight of sorghum and soybean, respectively, when hard water was used, as a percent reduction of the weight of the control after 15 days. The plants were harvested and weighed to determine the fresh weight.

Bartlett's test (commonly used in the agricultural business) was used to statistically analyze the results. It was determined that for the height reduction of sorghum, the results for the use of MIPAS or AMS at 0 ppm water hardness are not significantly different from the no adjuvant case. The results for the use of MIPAS at 342 ppm of water hardness were significantly different than the no adjuvant case, but they were not significantly different than the AMS results. The fresh weight of sorghum results for the use of MIPAS or AMS at 0 ppm water hardness are not significantly different from the no adjuvant case. The results for the use of the three highest concentrations of MIPAS and the two higher concentrations of AMS at 342 ppm of water hardness were significantly different than the no adjuvant case, but the MIPAS and AMS results were not significantly different from each other.

The height reduction of soybean and the weight reduction of soybean results for the use of MIPAS or AMS at 0 ppm water hardness and at 342 ppm water hardness are not significantly different from the no adjuvant case.

I claim:

1. A method of enhancing inhibition of plant growth comprising mixing a herbicide, an adjuvant and water to form a herbicidal mixture and applying the herbicidal mixture to the plant, wherein the adjuvant is isopropylammonium sulfate.

2. The method of claim 1, wherein the plant is morningglory.

3. The method of claim 1, wherein the plant is velvetleaf.

4. The method of claim 1, wherein the plant is grain sorghum.

5. The method of claim 1, wherein the plant is soybeans.

6. The method of claim 1, wherein the herbicide is glyphosate.
